(19) United States
(12) Patent Application Publication
(10) Pub. No.: US 2015/0113995 A1
(43) Pub. Date: Apr. 30, 2015

(54) ISOTHERMAL COMPRESSION TYPE HEAT ENGINE

(71) Applicant: Yuanming Yi, Guangdong (CN)

(72) Inventor: Yuanming Yi, Guangdong (CN)

(21) Appl. No.: 14/386,965

(22) PCT Filed: Jul. 24, 2012
(86) PCT No.: PCT/CN2012/079105

§ 371 Date: Dec. 10, 2014

(30) Foreign Application Priority Data
Mar. 20, 2012 (CN) 201210076278.8

(51) Int. Cl. F02C 3/04

(52) U.S. Cl. CPC F02C 3/04
USPC 60/772; 60/726

(57) ABSTRACT

The present invention relates to an isothermal compression type heat engine using air as a heat working medium. It is technically characterized as follows. An air compressor is used to replace an adiabatic air compressor. Two engineering courses being air compression and expansion work are performed separately in different engine members, so as to significantly increase a working pressure of the heat engine. Temperature gradient type heat preservation composite tubes are disposed to recycle remaining heat of exhaust gas with high efficiency, so as to distinctly improve the heat efficiency of the heat engine. When necessary, the isothermal air compressor and a low-temperature refrigerating device are used in coordination, so that toxic and harmful gas components in the exhaust gas are automatically condensed and liquefied, and are separated from clean gas under a artificial low-temperature environment, and then are collected to be used as chemical raw materials, so as to implement zero discharge and zero pollution of toxic and harmful materials in the exhaust gas of the engine.

### TECHNICAL FIELD

The present invention relates to a heat engine, and particularly to a process method and apparatus for an isothermal compression type heat engine using air as a heat working medium and having significantly improved heat efficiency.

### BACKGROUND ART

At present, a heat engine using air as a heat working medium typically adopts the air compression manner of adiabatic compression. Especially for a piston-type internal combustion engine, two different engineering courses being air compression and expansion work in the engine are set for long to be performed sequentially within a same cylinder. Thereby, mechanical work consumed during the engineering course of air compression is rendered extremely great, making it impossible to increase the working pressure. Meanwhile, remaining heat of exhaust gas of the heat engine has a low recovery rate and extremely low utilization efficiency, and toxic and harmful materials in the exhaust gas are usually left to be discharged to ambient environment, thereby resulting in low efficiency of the heat engine and serious environmental pollution.

### SUMMARY OF THE INVENTION

The object of the present invention is to provide a new method and apparatus for operating an isothermal compression type heat engine. The method and apparatus are employed to greatly increase a working pressure of a heat working medium gas, to recycle remaining heat of exhaust gas of the heat engine with high efficiency and to significantly improve efficiency of the heat engine, and when necessary, to realize zero discharge and zero pollution of toxic and harmful materials in the exhaust gas.

The technical solution of the present invention is as follows.

A method for operating an isothermal compression type heat engine is provided. Its heat working cycle involves using air as a heat working medium, using an air compressor to increase air pressure and feeding the compressed air into a combustion chamber for being combusted with fuel, which compressed air absorbs heat from the combustion chamber to generate volume expansion to drive an expander to operate and generate a mechanical output.

The heat working cycle uses an isothermal air compressor to perform multistage isothermal compression on air to increase a working pressure of the heat working medium gas. Two engineering courses being air compression and expansion work are performed separately in different engine members. Temperature gradient-type heat preservation composite tubes which recycle remaining heat of exhaust gas of the heat engine with high efficiency are arranged. When necessary, the isothermal air compressor and a low-temperature refrigerating device are used in coordination, so that toxic and harmful gas components in the exhaust gas are automatically condensed and liquefied at low-temperature sections of the heat preservation composite tubes, and are recycled after being completely separated from clean air components. The heat working cycle is performed under two different working conditions, i.e., one is that the isothermal air compressor, under a room-temperature environment, sucks room-temperature normal-pressure air and compresses it into room-temperature high-pressure air, and the other is that the isothermal air compressor, under a artificial low-temperature environment, sucks low-temperature air and compresses it into low-temperature high-pressure air.

Under room-temperature environment working conditions, the isothermal air compressor sucks room-temperature normal-pressure air from a room-temperature environment, performs multistage isothermal compression on the room-temperature normal-pressure air and compresses it into room-temperature high-pressure air. The room-temperature high-pressure air, after flowing out of the isothermal air compressor, enters an inner tube of the heat preservation composite tube via a heat preservation high-pressure gas tank, and performs heat convection with intense-heat exhaust gas flowing out of an outlet of the expander and entering an outer tube of the heat preservation composite tube. The room-temperature high-pressure air absorbs heat in the heat preservation composite tube to perform constant-pressure volume expansion, and then enters the combustion chamber for being combusted with fuel, to generate volume expansion again. The high-temperature high-pressure combustion gas flow drives the expander to operate and generate a mechanical output, and the expander drives the isothermal air compressor and a working machine to operate normally. Meanwhile, a small amount of room-temperature high-pressure air within the heat preservation high-pressure gas tank is fed to internal-cooling type refrigerant flowing space within the expander through a heat preservation high-pressure gas conduit, and absorbs heat from the expander to be cooled to generate volume expansion, followed by joining a high-temperature high-pressure combustion gas flow flowing out of the combustion chamber, thereby driving the expander to operate and apply work. Exhaust gas discharged from the outlet of the expander flows towards a room-temperature cold end via the outer tube of the heat preservation composite tube, exchanges heat with the room-temperature high-pressure air flowing from the room-temperature cold end into the inner tube of the heat preservation composite tube and is cooled before being discharged to ambient environment. Thus, a heat cycle is formed.

Under artificial low-temperature environment working conditions, the isothermal air compressor sucks low-temperature air from a artificial low-temperature environment, performs multistage isothermal compression on the low-temperature air and compresses it into low-temperature high-pressure air. The low-temperature high-pressure air, after flowing out of the isothermal air compressor, enters a heat preservation high-pressure gas tank before flowing into an inner tube of a first heat preservation composite tube, performs heat convection with intense-heat exhaust gas flowing out of an outlet of the expander and entering an outer tube of the first heat preservation composite tube. The low-temperature high-pressure air absorbs heat in the first heat preservation composite tube to perform constant-pressure volume expansion, and then enters the combustion chamber for being combusted with fuel, to generate volume expansion again. The high-temperature high-pressure combustion gas flow drives the expander to operate and generate a mechanical output, and the expander drives the isothermal air compressor, a refrigerating device and a working machine to operate normally. Meanwhile, a small amount of low-temperature high-pressure air within the heat preservation high-pressure gas tank is fed to internal-cooling type refrigerant flowing space within the expander through a heat preservation high-pressure gas conduit, and absorbs heat from the expander to be cooled to generate volume expansion, followed by joining a high-temperature high-pressure combustion gas flow flowing out of the combustion chamber, thereby driving the expander to operate and apply work. Intense-heat exhaust gas discharged from the outlet of the expander flows from a hot end towards a low-temperature cold end via the outer tube of the first heat preservation composite tube, exchanges heat with the low-temperature high-pressure air flowing from the low-temperature cold end into the inner tube of the first heat preservation composite tube and is cooled before toxic and harmful gas components in the exhaust gas are automatically condensed and liquefied or solidified at low-temperature sections of the first heat preservation composite tube, enter a collector for toxic and harmful materials of the exhaust gas after being separated from clean gas components of the exhaust gas, and are recycled as chemical raw materials. Clean gas of the exhaust gas enters an outer tube of a second heat preservation composite tube via a low-temperature end of the outer tube of the first heat preservation composite tube, before flowing from the low-temperature cold end into a natural room-temperature end through the outer tube of the second composite tube, performs heat convection with room-temperature air flowing from the natural room-temperature end into an inner tube of the second composite tube, and is discharged to ambient environment after a temperature rise; and room-temperature normal-pressure fresh air enters the inner tube of the second heat preservation composite tube, exchanges heat with clean gas of the exhaust gas in the outer tube, and is cooled before entering a artificial low-temperature environment. Thus, a heat cycle is formed.

An isothermal compression type heat engine apparatus comprises an isothermal air compressor, a combustion chamber, and an expander connected to an outlet of the combustion chamber. The apparatus further includes a heat preservation high-pressure gas tank, a first heat preservation composite tube, a combustion chamber, an expander and a heat preservation high-pressure gas conduit. Alternatively, the apparatus further includes a low-temperature refrigerating device, a artificial low-temperature chamber, a second heat preservation composite tube, and a collector for toxic and harmful materials of the exhaust gas.

Under room-temperature environment working conditions, a gas inlet of the isothermal air compressor is in communication with ambient environment. An outlet of the isothermal air compressor is connected to an inner tube of the first heat preservation composite tube via the heat preservation high-pressure gas tank. The other end of the inner tube of the first heat preservation composite tube is connected to a gas inlet of the combustion chamber. A gas outlet of the combustion chamber is connected to a gas inlet of the expander. An outlet of the expander is connected at a hot end to the outer tube of the first heat preservation composite tube. One end of the heat preservation high-pressure gas conduit is connected to the heat preservation high-pressure gas tank and the other end thereof is connected to an inlet of internal-cooling type refrigerant flowing space within the expander. The outer tube of the first heat preservation composite tube is in communication with ambient environment at a room-temperature cold end. The expander is configured to drive the isothermal air compressor and a working machine to operate normally. Thus, a heat cycle is formed.

Under artificial low-temperature environment working conditions, the isothermal air compressor, the low-temperature refrigerating device, the heat preservation high-pressure gas tank, the second heat preservation composite tube, and the collector for toxic and harmful materials of the exhaust gas all are provided within the artificial low-temperature chamber. A gas inlet of the isothermal air compressor is in communication with ambient environment via an inner tube of the second heat preservation composite tube extending through the artificial low-temperature chamber. A gas outlet of the isothermal air compressor is connected to the inner tube of the first heat preservation composite tube via the heat preservation high-pressure gas tank. The other end of the inner tube of the first heat preservation composite tube is connected to an inlet of the combustion chamber. An outlet of the combustion chamber is connected to a gas inlet of the expander. An outlet of the expander is connected at a hot end to an outer tube of the first heat preservation composite tube. The outer tube of the first heat preservation composite tube is connected at low-temperature sections to the collector for toxic and harmful materials of the exhaust gas via a branch pipe. One end of the heat preservation high-pressure gas conduit is connected to the heat preservation high-pressure gas tank and the other end thereof is connected to an inlet of internal-cooling type refrigerant flowing space within the expander. The outer tube of the first heat preservation composite tube is connected to the outer tube of the second heat preservation composite tube at a low-temperature end of the heat preservation composite tube. One end of the inner tube of the second heat preservation composite tube is in communication with ambient environment, and the other end thereof is connected to the gas inlet of the isothermal air compressor. The outer tube of the second heat preservation composite tube is in communication with ambient environment. The expander is configured to drive the isothermal air compressor, the low-temperature refrigerating device and a working machine to operate normally. Thus, a heat cycle is formed.

The combustion chamber refers to a combustion chamber including a fuel supply device and an ignition member.

The expander can be a turbotype steam turbine, and can also be an expander composed of cylinder, piston, connecting rod, and crankshaft.

A structure-combined configuration in which the combustion chamber is connected to the expander can be one identical to that in which in an existing combustion gas turbine a combustion chamber is connected to an expander, can be one identical to that in which in an existing piston-type internal combustion engine a combustion chamber is connected to an expander, or can be one identical to that in which in an existing turbotype steam turbine a combustion chamber is connected to an expander.

The expander drives the isothermal air compressor, the low-temperature refrigerating device and the working machine to operate normally, and power drive of the expander can be electric drive, gearbox drive, coaxial drive, or hydraulic drive.

In one embodiment of the present invention, pressure of room-temperature high-pressure air after being compressed by the isothermal air compressor under room-temperature environment working conditions or pressure of low-temperature high-pressure air after being compressed by the isothermal air compressor under artificial low-temperature environment working conditions can be 16 atmospheric pressure to 100 atmospheric pressure or 100 atmospheric pressure to 1000 atmospheric pressure, or can also be greater than 1000 atmospheric pressure.

The present invention utilizes the technical measures as follows: replacing an adiabatic air compressor by an isothermal air compressor, arranging the two engineering courses being air compressor and expansion work to be performed separately in different engine members to greatly increase a working pressure of the heat engine, disposing temperature gradient type heat preservation composite tubes for heat convection, and when necessary, using the isothermal air compressor and a low-temperature refrigerating device in coordination. Accordingly, efficiency of the heat engine is significantly improved and when necessary, zero discharge and zero pollution of toxic and harmful materials in the exhaust gas are implemented.

### BRIEF DESCRIPTION OF THE DRAWINGS

The present invention is hereinafter described in details in conjunction with the accompanying figures.

FIG. 1 is a structural diagram schematically showing a method for operating an isothermal compression type heat engine under room-temperature environment working conditions and an apparatus using the same.

FIG. 2 is a structural diagram schematically showing a method for operating an isothermal compression type heat engine under artificial low-temperature environment working conditions and an apparatus using the same.

### DETAILED DESCRIPTION OF THE EMBODIMENTS

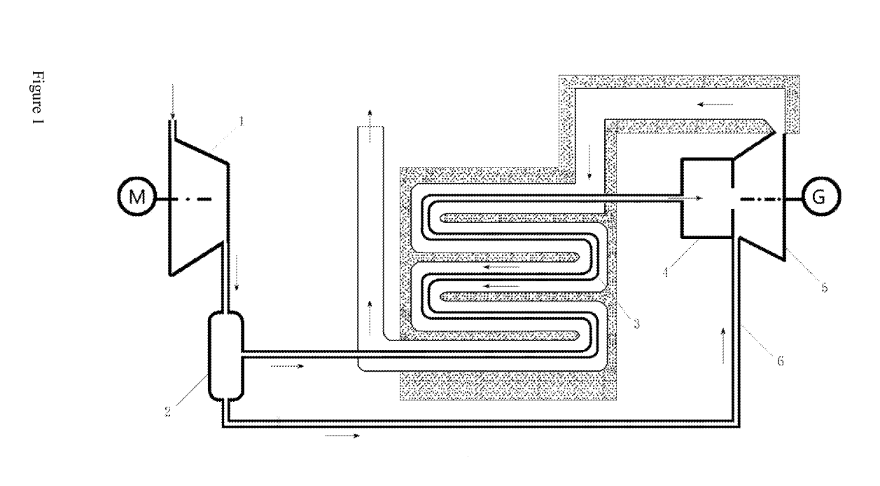

Referring to FIG. 1, a heat working system of the present invention uses air as a heat working medium, absorbs room-temperature normal-pressure air from a room-temperature environment, increases air pressure via compression and feeds the compressed air into a combustion chamber for being combusted with fuel, which compressed air absorbs heat from the combustion chamber to generate volume expansion to drive an expander to operate and generate a mechanical output.

A method for operating an isothermal compression type heat engine under room-temperature environment working conditions according to the present invention is characterized as follows. An isothermal air compressor is used in place of an existing adiabatic air compressor to increase a working pressure of the heat working medium gas. Two engineering courses being air compression and expansion work are performed separately in different engine members. A temperature gradient type heat preservation composite tube which recycles remaining heat of exhaust gas of the heat engine with high efficiency is arranged. The isothermal air compressor sucks room-temperature normal-pressure air from a room-temperature environment, performs multistage isothermal compression on the room-temperature normal-pressure air and compresses it into room-temperature high-pressure air. The room-temperature high-pressure air, after flowing out of the isothermal air compressor, flows into an inner tube of the heat preservation composite tube via a heat preservation high-pressure gas tank, performs heat convection in the temperature gradient type heat preservation tube with intense-heat exhaust gas flowing out of an outlet of the expander and entering an outer tube of the heat preservation composite tube via a hot end. The room-temperature high-pressure air absorbs heat in the heat preservation composite tube to perform constant-pressure volume expansion, and then enters the combustion chamber for being combusted with fuel, to generate volume expansion again. The high-temperature high-pressure combustion gas flow drives the expander to operate and generate a mechanical output, to drive the isothermal air compressor and a working machine to operate normally. Meanwhile, a small amount of room-temperature high-pressure air within the heat preservation high-pressure gas tank is fed to internal-cooling type refrigerant flowing space within the expander through a heat preservation high-pressure gas conduit, and absorbs heat from the expander to be cooled to generate volume expansion, before joining a high-temperature high-pressure combustion gas flow flowing out of the combustion chamber, thereby driving the expander to operate and apply work. Exhaust gas discharged from the outlet of the expander flows towards a room-temperature cold end via the outer tube of the heat preservation composite tube, performs heat convection with the room-temperature high-pressure air flowing from the room-temperature cold end into the inner tube of the heat preservation composite tube and is cooled before being discharged to ambient environment. Thus, a heat cycle is formed.

An apparatus for an isothermal compression type heat engine under room-temperature environment working conditions according to the present invention uses the above method for implementation. As shown in FIG. 1, an isothermal compression type heat engine apparatus comprises: an isothermal air compressor 1 which suctions room-temperature normal-pressure air from ambient environment; a combustion chamber 4; and an expander 5 whose inlet is connected to an outlet of the combustion chamber 4. Additionally, the apparatus further includes: a heat preservation high-pressure gas tank 2 which is connected to an outlet of the isothermal air compressor 1 via a gas conduit; a heat preservation composite tube 3 in which one end of an inner tube is connected to an outlet of the heat preservation high-pressure gas tank 2 and the other end is connected to an inlet of the combustion chamber 4 and one end of an outer tube is in communication with ambient environment and the other end is connected to an outlet of the expander 5; and a high-pressure gas conduit 6 whose inlet is connected to the heat preservation high-pressure gas tank 2 and whose outlet is connected to refrigerant flowing space within the expander 5. The heat preservation composite tube 3 is in communication with ambient environment at a room-temperature cold end. The expander 5 is configured to drive the isothermal air compressor 1 and a working machine to operate normally. Thus, a heat cycle is formed.

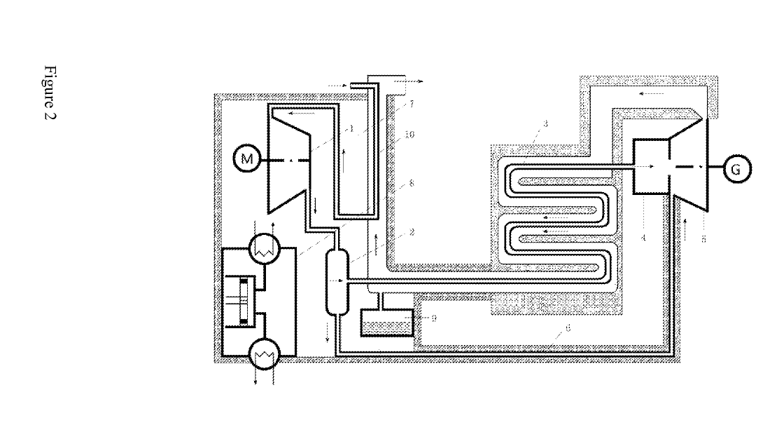

Referring to FIG. 2, a heat working system of the present invention uses air as a heat working medium, sucks air via an air compressor, increases air pressure via compression and feeds the compressed air into a combustion chamber for being combusted with fuel, which compressed air absorbs heat from the combustion chamber to generate volume expansion to drive an expander to operate and generate a mechanical output.

A method for operating an isothermal compression type heat engine under artificial low-temperature environment working conditions according to the present invention is characterized as follows. An isothermal air compressor is used in place of an existing adiabatic air compressor to increase a working pressure of the heat working medium gas. Two engineering courses being air compression and expansion work are performed separately in different engine members. A temperature gradient type heat preservation composite tube which recycles remaining heat of exhaust gas of the heat engine with high efficiency is arranged. The isothermal air compressor and a low-temperature refrigerating device are used in coordination, so that toxic and harmful gas components in exhaust gas are automatically condensed and liquefied at low-temperature sections of the heat preservation composite tube, and are recycled after being completely separated from clean gas components. The isothermal air compressor sucks low-temperature air from a artificial low-temperature environment, performs multistage isothermal compression on the low-temperature air and compresses it into low-temperature high-pressure air. The low-temperature high-pressure air, after flowing out of the isothermal air compressor, flows into an inner tube of the heat preservation composite tube via a heat preservation high-pressure gas tank, performs heat convection with intense-heat exhaust gas flowing out of an outlet of the expander and entering an outer tube of the heat preservation composite tube. The low-temperature high-pressure air absorbs heat in the heat preservation composite tube to perform constant-pressure volume expansion, and then enters the combustion chamber for being combusted with fuel, to generate volume expansion again. The high-temperature high-pressure combustion gas flow drives the expander to operate and generate a mechanical output, thereby driving the isothermal air compressor, a low-temperature refrigerating device and a working machine to operate normally. Meanwhile, a small amount of low-temperature high-pressure air within the heat preservation high-pressure gas tank is fed to internal-cooling type refrigerant flowing space within the expander through a heat preservation high-pressure gas conduit, and absorbs heat from the expander to be cooled to generate volume expansion, followed by joining a high-temperature high-pressure combustion gas flow flowing out of the combustion chamber, thereby driving the expander to operate and apply work. Intense-heat exhaust gas discharged from the outlet of the expander enters the outer tube of the heat preservation composite tube, performs heat convection with the low-temperature high-pressure air flowing from the low-temperature cold end into the inner tube of the heat preservation composite tube; and after entering the low-temperature sections of the heat preservation composite tube, toxic and harmful gas components in the exhaust gas are automatically condensed and liquefied or solidified, are automatically separated from clean gas in the exhaust gas, and enter a collector for toxic and harmful materials of the exhaust gas from the outer tube of the heat preservation composite tube through a branch pipe, to be recycled as chemical raw materials. Clean gas of the exhaust gas performs heat convection with the room-temperature air via the second composite tube, and is discharged to ambient environment after a temperature rise; and room-temperature normal-pressure fresh air enters the inner tube of the second heat preservation composite tube, exchanges heat with clean gas of the exhaust gas in the outer tube, and is cooled before entering the artificial low-temperature environment. Thus, the heat cycle is formed.

An isothermal compression type heat engine apparatus under artificial low-temperature environment working conditions according to the present invention uses the above method for implementation. As shown in FIG. 2, an isothermal compression type heat engine apparatus under artificial low-temperature environment working conditions comprises: an isothermal air compressor 1 which suctions low-temperature air from a artificial low-temperature environment; a combustion chamber 4; and an expander 5 which is connected to an outlet of the combustion chamber 4. Additionally, the apparatus further includes: a heat preservation high-pressure gas tank 2 which is connected to an outlet of the isothermal air compressor 1 via a gas conduit; a first heat preservation composite tube 3 of which one end of an inner tube is connected to an outlet of the heat preservation high-pressure gas tank 2 and the other end is connected to an inlet of the combustion chamber 4, and of which one end of an outer tube is connected to an outer tube of a second heat preservation composite tube 10 and the other end is connected to an outlet of the expander 5; a heat preservation high-pressure gas conduit 6 whose inlet is connected to the heat preservation high-pressure gas tank 2 and whose outlet is connected to an inlet of refrigerant flowing space within the expander 5; a second heat preservation composite tube 10 of which one end of an outer tube is connected to a low-temperature end of the first heat preservation composite tube 3 and the other end is in communication with ambient environment, and of which one end of an inner tube is in communication with ambient environment and the other end is connected to a gas inlet of the isothermal air compressor 1; a collector 9 for toxic and harmful materials of the exhaust gas, which collector is connected at a artificial low-temperature chamber 7 to the outer tube of the first heat preservation composite tube 3 via a branch pipe; a low-temperature refrigerating device 8 which is used in coordination with the isothermal air compressor 1; and a artificial low-temperature chamber 7 which accommodates the isothermal air compressor 1, the heat preservation high-pressure gas tank 2, the low-temperature refrigerating device 8, the second heat preservation composite tube 10, the collector 9 for toxic and harmful materials of the exhaust gas and the low-temperature sections of the first heat preservation composite tube 3. The outer tube of the second heat preservation composite tube 10 is in communication with ambient environment. The expander 5 is configured to drive the isothermal air compressor 1, the low-temperature refrigerating device 8 and a working machine to operate normally. Thus, a heat cycle is formed.

According to the present invention, the combustion chamber 4 refers to a combustion chamber including a fuel supply device and an ignition member.

The expander 5 can be a turbotype steam turbine, and can also be an expander composed of cylinder, piston, connecting rod, and crankshaft.

A structure-combined configuration in which the combustion chamber 4 is connected to the expander 5 can be one identical to that in which in an existing combustion gas turbine a combustion chamber is connected to an expander, can be one identical to that in which in an existing piston-type internal combustion engine a combustion chamber is connected to an expander, or can be one identical to that in which in an existing turbotype steam turbine a combustion chamber is connected to an expander.

The expander 5 drives the isothermal air compressor 1, the low-temperature refrigerating device 8 and the working machine, and power drive of the expander can be electric drive, gearbox drive, coaxial drive, or hydraulic drive.

Referring to FIG. 1, procedures of using and operating an isothermal compression type heat engine apparatus under room-temperature environment working conditions according to the present invention are as follows.

1. An isothermal air compressor 1 is started. The isothermal air compressor 1 sucks room-temperature normal-pressure air from a natural room-temperature environment to apply multistage isothermal compression on the room-temperature normal-pressure air. The isothermal air compressor 1 discharges heat produced during a compression process into the natural room-temperature environment, before compressing the room-temperature normal-pressure air into room-temperature high-pressure air and feeding it into a heat preservation high-pressure gas tank 2.
2. The room-temperature high-pressure air enters an inner tube of a heat preservation composite tube 3 via the heat preservation high-pressure gas tank 2, before entering a combustion chamber 4 for being combusted with fuel, to form a high-temperature high-pressure combustion gas flow.
3. The high-temperature high-pressure combustion gas flow drives an expander 5 to operate and generate a mechanical output. Intense-heat exhaust gas whose temperature and pressure has been reduced flows from an outlet of the expander 5 into an outer tube of the heat preservation composite tube 3, flows from a high-temperature hot end of the outer tube of the heat preservation composite tube 3 to a room-temperature cold end, performs heat convection with the room-temperature high-pressure air flowing in the inner tube of the heat preservation composite tube 3 to form temperature gradient, and is cooled before being discharged from the room-temperature cold end of the outer tube of the heat preservation composite tube 3 to ambient environment.
4. A small amount of room-temperature high-pressure air is fed from the heat preservation high-pressure gas tank 2 through a heat preservation high-pressure gas conduit 6 to internal-cooling type refrigerant flowing space within the expander 5, absorbs heat from the expander 5 to be cooled to generate volume expansion before returning to a region of a gas inlet of the expander 5, and joins the high-temperature high-pressure combustion gas flow flowing out of the combustion chamber 4 to drive the expander 5 to operate and apply work.
5. The room-temperature high-pressure air in the inner tube of the heat preservation composite tube 3 exchanges heat with the intense-heat exhaust gas in the outer tube of the heat preservation composite tube 3. As temperature continuously rises, the volume continuously expands. The air enters the combustion chamber 4 for being combusted with fuel to form a high-temperature high-pressure combustion gas flow, thereby driving the expander 5 to operate. A normal working condition in which a preset mechanical output is produced occurs.
6. The expander 5 generates a normal mechanical output to drive the isothermal air compressor 1 and a working machine to operate normally.

Thus, a normal heat cycle working state of the isothermal compression type heat engine under the room-temperature environment working conditions proceeds.

Referring to FIG. 2, procedures of using and operating an isothermal compression type heat engine apparatus under artificial low-temperature environment working conditions according to the present invention are as follows.

1. A low-temperature refrigerating device 8 is started. The temperature of a artificial low-temperature chamber 7 is reduced to a set low temperature.
2. An isothermal air compressor 1 is started. The isothermal air compressor 1 sucks low-temperature air from an inner tube of a second heat preservation composite tube 10 to perform multistage isothermal compression on the low-temperature air, compresses the low-temperature air into low-temperature high-pressure air and feeds it into a heat preservation high-pressure gas tank 2.
3. The low-temperature high-pressure air enters an inner tube of a first heat preservation composite tube 3 via the heat preservation high-pressure gas tank 2, before entering a combustion chamber 4 for being combusted with fuel, to form a high-temperature high-pressure combustion gas flow.
4. The high-temperature high-pressure combustion gas flow drives an expander 5 to operate and generate a mechanical output. Intense-heat exhaust gas whose temperature and pressure have been reduced flows from an outlet of the expander 5 into an outer tube of the first heat preservation composite tube 3, flows from a high-temperature hot end of the outer tube of the first heat preservation composite tube 3 to a low-temperature cold end, performs heat convection with the low-temperature high-pressure air flowing from the low-temperature cold end of the inner tube of the first heat preservation composite tube 3. After entering low-temperature sections, toxic and harmful gas components in the exhaust gas are automatically condensed and liquefied or solidified, are automatically separated from clean gas components in the exhaust gas, and enter a collector 9 for toxic and harmful materials of the exhaust gas from the first heat preservation composite tube 3 via a branch pipe, to be recycled as chemical raw materials.
5. A small amount of room-temperature high-pressure air within the heat preservation high-pressure gas tank 2 is fed to internal-cooling type refrigerant flowing space within the expander 5 through a heat preservation high-pressure gas conduit 6, absorbs heat from the expander 5 to be cooled to generate volume expansion before joining the high-temperature high-pressure combustion gas flow flowing out of the combustion chamber 4 to drive the expander 5 to operate and apply work.
6. Clean gas in the exhaust gas enters an outer tube of the second heat preservation composite tube 10 via a low-temperature cold end of the outer tube of the first heat preservation composite tube 3, performs heat convection with room-temperature air flowing from the room-temperature end of the inner tube of the second heat preservation composite tube 10, and after a temperature rise, is discharged to ambient environment via an outlet of the outer tube of the second heat preservation composite tube 10.
7. Room-temperature normal-pressure fresh air flows in from the room-temperature end of the inner tube of the second heat preservation composite tube 10, performs heat convection with low-temperature clean air in the outer tube of the second heat preservation composite tube 10, and is cooled before entering a artificial low-temperature chamber 7 for further cooling, and then enters the isothermal air compressor 1.
8. The low-temperature high-pressure air in the inner tube of the first heat preservation composite tube 3 exchanges heat with intense-heat exhaust gas in the outer tube of the first heat preservation composite tube 3. As the temperature of the low-temperature high-pressure air continuously rises, its volume expands continuously. The air enters the combustion chamber 4 for being combusted with fuel to form a high-temperature high-pressure combustion gas flow, thereby driving the expander 5 to operate. A normal working condition in which a preset mechanical output is produced occurs.
9. The expander 5 generates a normal mechanical output to drive the isothermal air compressor 1, the low-temperature refrigerating device 8 and a working machine to operate normally.

Thus, a normal heat cycle working state of the isothermal compression type heat engine under the artificial low-temperature environment working conditions proceeds.

The process method for an isothermal compression type heat engine and the apparatus using the same according to the present invention employ an isothermal air compressor to replace an adiabatic air compressor, thereby greatly increasing a working pressure of the heat engine; uses temperature gradient type heat preservation composite tubes to recycle remaining heat of exhaust gas of the heat engine with high efficiency, thereby significantly improving efficiency of the heat engine and considerably saving power production costs; and when necessary, can also use the isothermal air compressor and a low-temperature refrigerating device in coordination to completely purify industrial waste gas discharged from the heat engine and realize zero discharge and zero pollution of toxic and harmful materials. The present application has a wide range of applications. Applications of the present invention in principle, industry and commerce all are included in the range of the claims of the present invention. Any improved technologies based on the above are derived from the claims of the present invention.

1. A method for operating an isothermal compression type heat engine, a heat working cycle of the heat engine using air as a heat working medium, using an air compressor to increase air pressure and feeding the compressed air into a combustion chamber for being combusted with fuel, the compressed air absorbing heat from the combustion chamber to generate volume expansion, to drive an expander to operate and generate a mechanical output,
characterized in that the heat working cycle uses an isothermal air compressor to perform multistage isothermal compression on air to increase a heat working medium gas working pressure of the air, wherein air compression and expansion work are performed separately in different engine members.

2. The method according to claim 1, characterized in that the compressed air first enters a heat preservation high-pressure gas tank.

3. The method according to claim 2, characterized in that a small amount of high-pressure air within said heat preservation high-pressure gas tank is fed to internal-cooling type refrigerant flowing space within the expander through a heat preservation high-pressure gas conduit, and absorbs heat from the expander to be cooled to generate volume expansion, followed by joining a high-temperature high-pressure combustion gas flow flowing out of the combustion chamber.

4. The method according to claim 2, characterized in that the high-pressure air in the heat preservation high-pressure gas tank then flows from a cold end into an inner tube of a first heat preservation composite tube.

5. The method according to claim 4, characterized in that the high-pressure air, after exiting the first heat preservation composite tube, enters the combustion chamber for being combusted with fuel, and the resulting high-temperature high-pressure combustion gas flow drives the expander to operate.

6. The method according to claim 5, characterized in that exhaust gas discharged from an outlet of the expander flows towards the cold end via an outer tube of the first heat preservation composite tube, to exchange heat with the high-pressure air flowing from the cold end into the inner tube of the first heat preservation composite tube, wherein the high-pressure air is subjected to constant-pressure volume expansion in the inner tube of the first heat preservation composite tube.

7. The method according to claim 1, characterized in that under room-temperature environment working conditions, the isothermal air compressor sucks room-temperature normal-pressure air from a room-temperature environment, performs multistage isothermal compression on the room-temperature normal-pressure air and compresses it into room-temperature high-pressure air.

8. The method according to claim 6, characterized in that under room-temperature environment working conditions, the isothermal air compressor sucks room-temperature normal-pressure air from a room-temperature environment, performs multistage isothermal compression on the room-temperature normal-pressure air and compresses it into room-temperature high-pressure air; and the exhaust gas exchanges heat in the first heat preservation composite tube with the room-temperature high-pressure air flowing from a room-temperature cold end into the inner tube of the first heat preservation composite tube and is cooled before being discharged to ambient environment.

9. The method according to claim 6, characterized in that under artificial low-temperature environment working conditions, the isothermal air compressor sucks low-temperature air from a artificial low-temperature environment, performs multistage isothermal compression on the low-temperature air and compresses it into low-temperature high-pressure air; and the exhaust gas exchanges heat in the first heat preservation composite tube with the low-temperature high-pressure air flowing from a low-temperature cold end into the inner tube of the first heat preservation composite tube and is cooled before toxic and harmful gas components in the exhaust gas are automatically condensed and liquefied or solidified at low-temperature sections of the first heat preservation composite tube and after being separated from clean gas components of the exhaust gas, enter a collector for toxic and harmful materials of the exhaust gas.

10. The method according to claim 9, characterized in that clean gas of the exhaust gas enters an outer tube of a second heat preservation composite tube via a low-temperature end of the outer tube of the first heat preservation composite tube, before flowing from the low-temperature cold end into a natural room-temperature end through the outer tube of the second composite tube, performs heat convection with room-temperature air flowing from a natural room-temperature end of an inner tube of the second composite tube, and is discharged to ambient environment after a temperature rise; and room-temperature normal-pressure fresh air enters the inner tube of the second heat preservation composite tube, exchanges heat with clean air of the exhaust gas in the outer tube, and is cooled before entering the artificial low-temperature environment.

11. The method according to claim 1, characterized in that pressure of high-pressure air after being compressed by the isothermal air compressor is 16 atmospheric pressure to 100 atmospheric pressure or 100 atmospheric pressure to 1000 atmospheric pressure, or can also be greater than 1000 atmospheric pressure.

12. The method according to claim 1, characterized in that the expander drives a working machine, an optional isothermal air compressor and an optional low-temperature refrigerating device to work.

13. An isothermal compression type heat engine apparatus, comprising: an air compressor, a combustion chamber, and an expander connected to an outlet of the combustion chamber, characterized in that said air compressor, which is an isothermal air compressor, performs multistage isothermal compression on air to increase a heat working medium gas working pressure of the air, and feeds the compressed air into the combustion chamber for being combusted with fuel; and the compressed air absorbs heat from the combustion chamber to generate volume expansion to drive the expander to operate and generate a mechanical output, wherein air compression and expansion work are performed separately in different engine members.

14. The isothermal compression type heat engine apparatus according to claim 13, characterized in that a heat preservation high-pressure gas tank is provided, which is connected to an outlet of the isothermal air compressor via a gas conduit.

15. The isothermal compression type heat engine apparatus according to claim 14, characterized in that a heat preservation high-pressure gas conduit is provided, one end of the heat preservation high-pressure gas conduit being connected to the heat preservation high-pressure gas tank and the other end thereof being connected to an inlet of internal-cooling type refrigerant flowing space within the expander.

16. The isothermal compression type heat engine apparatus according to claim 14, characterized in that a first heat preservation composite tube is provided, which includes an inner tube and an outer tube, wherein one end of the inner tube is connected to an outlet of the heat preservation high-pressure gas tank and the other end thereof is connected to an inlet of the combustion chamber, and one end of the outer tube is connected to an outlet of the expander.

17. The isothermal compression type heat engine apparatus according to claim 13, characterized in that a gas inlet of the isothermal air compressor is in communication with ambient environment under room-temperature environment working conditions.

18. The isothermal compression type heat engine apparatus according to claim 16, characterized in that under the room-temperature environment working conditions, the gas inlet of the isothermal air compressor is in communication with ambient environment, and the other end of the outer tube is in communication with ambient environment.

19. The isothermal compression type heat engine apparatus according to claim 16, characterized in that under artificial low-temperature environment working conditions, a low-temperature refrigerating device and a collector for toxic and harmful materials of the exhaust gas are provided.

20. The isothermal compression type heat engine apparatus according to claim 19, characterized in that the outer tube of said first heat preservation composite tube is connected at low-temperature sections to the collector for toxic and harmful materials of the tail gas via a branch pipe.

21. The isothermal compression type heat engine apparatus according to claim 19, characterized in that a second heat preservation composite tube is further provided, the second heat preservation composite tube including an inner tube and an outer tube, wherein the outer tube of the first heat preservation composite tube is connected to an end of the outer tube of the second heat preservation composite tube at a low-temperature end of the first heat preservation composite tube and the other end of the outer tube of the second heat preservation composite tube is in communication with ambient environment; and one end of the inner tube of the second heat preservation composite tube is in communication with ambient environment and the other end thereof is connected to the gas inlet of the isothermal air compressor.

22. The isothermal compression type heat engine apparatus according to claim 21, characterized in that said isothermal air compressor, said low-temperature refrigerating device, said heat preservation high-pressure gas tank, said second heat preservation composite tube, and said collector (9) for toxic and harmful materials of the exhaust gas all are provided within a artificial low-temperature chamber.

23. The isothermal compression type heat engine apparatus according to claim 13, characterized in that said chamber refers to a combustion chamber including a fuel supply device and an ignition member.

24. The isothermal compression type heat engine apparatus according to claim 13, characterized in that the expander can be a turbotype steam turbine, and can also be an expander composed of cylinder, piston, connecting rod, and crankshaft.

25. The isothermal compression type heat engine apparatus according to claim 13, characterized in that a structure-combined configuration in which the combustion chamber is connected to the expander can be one identical to that in which in an existing combustion gas turbine a combustion chamber is connected to an expander, can be one identical to that in which in an existing piston-type internal combustion engine a combustion chamber is connected to an expander, or can be one identical to that in which in an existing turbotype steam turbine in which a combustion chamber is connected to an expander.

26. The isothermal compression type heat engine apparatus according to claim 13, characterized in that the expander drives a working machine, an optional isothermal air compressor and an optional low-temperature refrigerating device to normally work, power drive of the expander being one selected from the group consisting of electric drive, gearbox drive, coaxial drive and hydraulic drive.

27. The isothermal compression type heat engine apparatus according to claim 13, characterized in that pressure of high-pressure air after being compressed by the isothermal air compressor is 16 atmospheric pressure to 100 atmospheric pressure or 100 atmospheric pressure to 1000 atmospheric pressure, or can also be greater than 1000 atmospheric pressure.
